(19) United States
(12) Patent Application Publication
(10) Pub. No.: US 2007/0120804 A1
(43) Pub. Date: May 31, 2007

(54) LCD module and control method

(75) Inventor: Po-Hsien Su, Taipei City (TW)

Correspondence Address: BACON & THOMAS, PLLC, 625 SLATERS LANE, FOURTH FLOOR, ALEXANDRIA, VA, 22314, US

(73) Assignee: Jimi Hung, Taipei (TW)

(21) Appl. No.: 11/286,395

(22) Filed: Nov. 25, 2005

(51) Int. Cl. G09G 3/36

(52) U.S. Cl. 345/99

(57) ABSTRACT

A TFT liquid crystal display (LCD) module comprising a timing controller and a reversal data generator is disclosed. The timing controller provides a plurality of signals to the column-driver and row-driver of LCD panel. The reversal data generator outputs a reversal data signal to the timing controller, which in turn outputs a non-periodic reversal signal to the column-driver. The generation of reversal data signal by the reversal data generator is independent of the timing of the timing controller, or the reversal data signal is a non-periodic signal and the non-periodic reversal signal will change its state within a specific time range posterior to the column start signal.

### BACKGROUND OF THE INVENTION

1. Field of the Invention

The present invention relates to a signal control circuit and control method, more particularly, to a TFT LCD module and control method that alters the characteristics of the reversal signal.

2. Description of the Related Art

FIG. 1 is the driver circuit diagram of a conventional TFT liquid crystal display module. The TFT liquid crystal display module comprises a liquid crystal display panel (LCD panel) 1, a column-driver 2, a row-driver 3 and a timing controller 4, wherein data displayed by LCD panel 1 are controlled by the timing controller 4, which sends respectively column start signal (STH), reversal signal (POL), latch signal (TP), row start signal (STV), row clock signal (CPV), and output enable signal (OE) to the LCD panel 1 through the row-driver 3 and the column-driver 2.

Among the LCD modules on the market, timing control signals are more complicated as the specifications for panel resolution differs. Whether the timing controller 4 is built in the LCD module or not is decided at the discretion of the LCD manufacturer.

The basic imaging unit of the LCD panel 1 is the pixel. A pixel in the panel structure behaves like a capacitor and displays when sufficient driving voltage is applied to both ends. The two voltages applied are respectively a common voltage and a data line voltage. In light of the capacitor effect of pixels of the LCD panel 1, if the voltages applied to both ends of the capacitor were not reversed, the displayed pixel would be constantly charged by the same voltage. Consequently, a certain quantity of electric charges would accumulate in the pixel electrodes. In more serious scenario, it would cause polarization of the liquid crystal and make pixels lose efficiency. In less serious cases, background color would exist on the LCD panel 1 and color contrast would also decrease. These effects are more pronounced in a high-resolution LCD panel 1. Thus the voltage signals that drive the pixels must be reversed at a certain time interval to neutralize the electric charges stored as a result of the capacitor effect.

FIG. 2 shows the driving signals provided by a conventional timing controller 4 to the row-driver 3 and column-driver 2, wherein the reversal signal POL is a periodic signal in reference to the timing of the column start signal STH. In the example of POL_1 or POL_2, which represents respectively the execution of pixel voltage signal reversal based on the period of one line or two lines. As to the timing, one-line reversal signal POL_1 reverses once every period of the column start signal STH, while two-line reversal signal POL_2 reverses once every two periods of the column start signal STH. In addition, by the TFT LCD control signal specifications, the state change of the reversal signal POL is valid only within a specific time range posterior to the row start signal STH.

Referring to FIG. 3, a diagram for one-line reversal signal POL_1 corresponding to the pixels in the first row of a LCD panel is shown. According to prior art, the one-line reversal signal POL_1 provided by the timing controller 4 decides the reversal state of each pixel in the first column of a LCD panel, while the reversal state of each pixel in each row is conditional upon the reversal state of the first pixel (i.e. the pixel in the firs column).

According to prior art, taking one-line reversal or two-line reversal rule as an example, the reversal of voltage between adjacent pixels to neutralize the electrical charges stored as a result of capacitor effect can improve the flickering and non-uniform luminance phenomena of a panel. However by the one-line or two-line reversal rule implemented by a periodic reversal signal, flickering and non-uniform luminance problems still exist when data displayed on the LCD panel 1 and the generation of reversal state by the reversal signal are synchronous. For example, when data displayed on the LCD panel 1 is mesh point data, the mesh point data might be synchronized with the reversal state generated by the reversal signal on the panel, causing flickering and non-uniform luminance.

The quality of reversal signal POL is associated with the flickering problem of the LCD panel 1. Poor quality reversal signal also lowers contrast. Thus when the output of reversal signal by the timing controller 4 is not well controlled, the LCD panel 1 would have flickering problem and the phenomenon of non-uniform luminance.

### SUMMARY OF THE INVENTION

In light that when data displayed on a LCD panel and the reversal state generated by a reversal signal on the panel are synchronous, the problems of flickering and non-uniform luminance of varying severity occur when periodic reversal signals are implemented following one-line reversal two-line reversal rules, or one plus two line reversal rules of prior art. In addressing such problems, the LCD industry tends to ignore the period factor of reversal signals. In other words, the non-periodic reversal signals might be the solution to improve the flickering and non-luminance problems of a LCD panel.

The TFT liquid crystal display module and control method according to the present invention provides a reversal data signal for reference to enable the timing controller to output a non-periodic reversal signal whose state change conforms to the specifications of TFT LCD control signals that the transition state and is valid only within certain time range posterior to the column start signal STH, and the generation of the reversal data signal is independent of the system clock of the timing controller or the reversal data signal is a non-periodic signal.

An object of the present invention is to provide a TFT liquid crystal display module where the reversal signal output from the timing controller to the column-driver is a non-periodic signal.

Another object of the present invention is to provide a TFT liquid crystal display module comprising a reversal data generator which outputs a reversal data signal to a timing controller so that the reversal signal output by the timing controller is a non-perodic signal.

A further object of the present invention is to provide a control method for a TFT liquid crystal display module characterized by referencing a reversal data signal to produce a non-periodic reversal signal where the generation of the reversal data signal is independent of the system clock of the timing controller.

Yet another object of the present invention is to provide a control method for a TFT liquid crystal display module characterized by referencing a reversal data signal to produce a non-periodic reversal signal where said reversal data signal is a non-periodic signal.

The TFT liquid crystal display module according to the present invention comprises a timing controller providing a plurality of signals to the column-driver and row-driver of a liquid crystal display panel and outputting a non-periodic reversal signal to the column-driver.

The liquid crystal display module also comprises a reversal data generator for outputting a reversal data signal to the timing controller. The reversal data generator is independent of the timing of the timing controller in the generation of the reversal data signal.

The reversal data signal is a non-periodic signal.

The timing controller outputs a column start signal to the column-driver and samples the reversal data signal based on the column start signal to output a non-periodic reversal signal.

The non-periodic reversal signal will change its state within a specific time range posterior to the column start signal.

The reversal data control method according to the present invention is implemented in a liquid crystal display module, comprising the steps of providing a reversal data signal; and sampling the reversal data signal to output a non-periodic reversal signal.

The control method comprises providing the reversal data signal to a timing controller, and the timing controller samples the reversal data signal to output a non-periodic reversal signal to the column-driver.

The control method comprises generating the reversal data signal independent of the timing of the timing controller.

The control method comprises random production of the reversal data signal to to make the reversal data signal a non-periodic signal.

Based on the TFT liquid crystal display module and reversal signal control method according to the present invention, the reversal signal provided by the timing controller to the column-driver is a non-periodic signal which is optimally adjusted to improve the flickering and non-uniform luminance problems of a LCD panel.

### BRIEF DESCRIPTION OF TIE DRAWINGS

FIG. 1 shows the block diagram of the driving system of a conventional liquid crystal display module.

FIG. 2 shows the timing diagram of the driving system of a conventional liquid crystal display module.

FIG. 3 shows the timing diagram of the pixels in the first column of a LCD panel corresponding to a column reversal signal POL according to a conventional liquid crystal display module.

FIG. 4 shows the block diagram of the driving system of a liquid crystal display module according to the invention.

FIG. 5 shows the timing diagram of a reversal signal POL corresponding to the column start signal STH according to the invention.

FIG. 6 shows the diagram of the pixels in the first column of a LCD panel corresponding to a column reversal signal POL according to the invention.

FIG. 7 shows the circuit diagram of a reversal data generator according to the invention.

FIG. 8 shows the circuit diagram of another embodiment of a reversal data generator according to the invention.

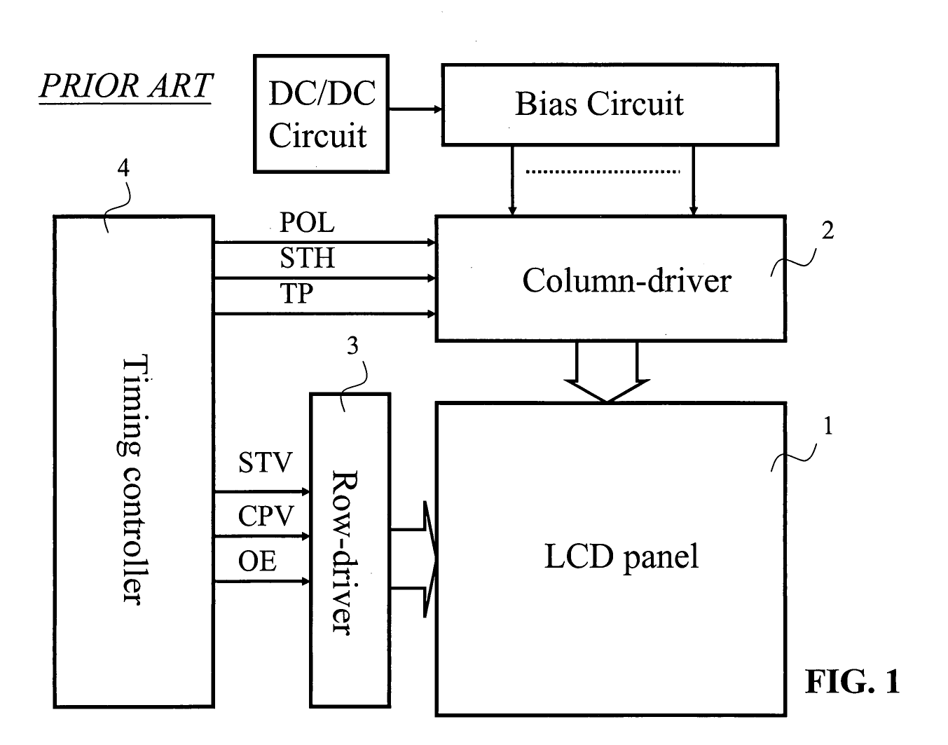

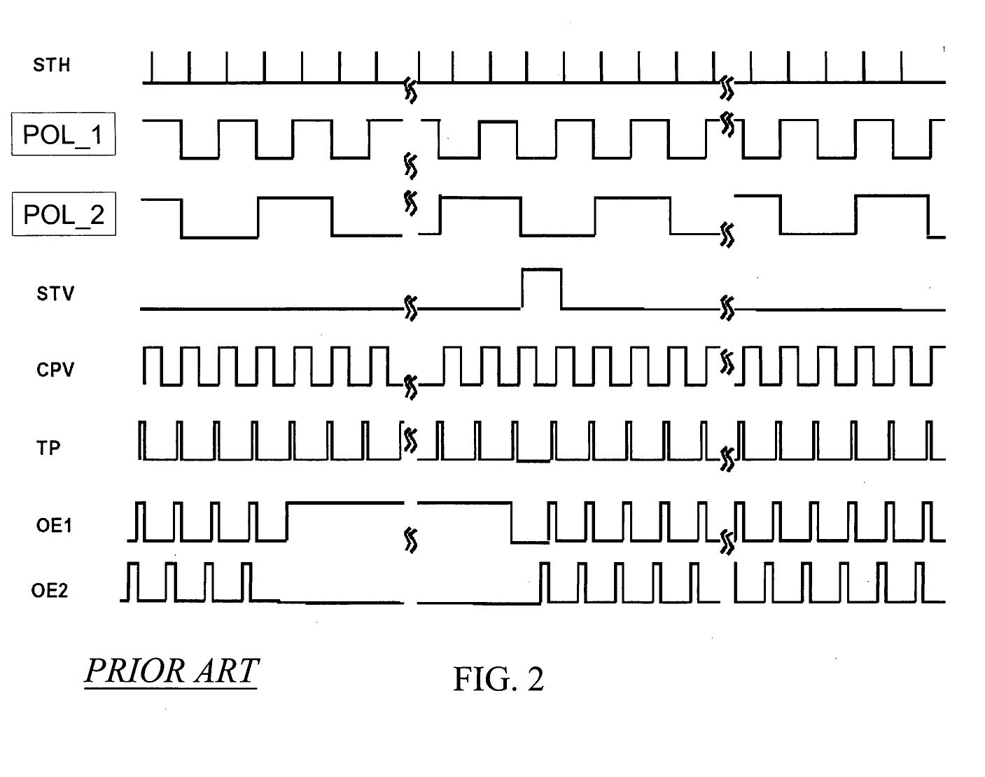

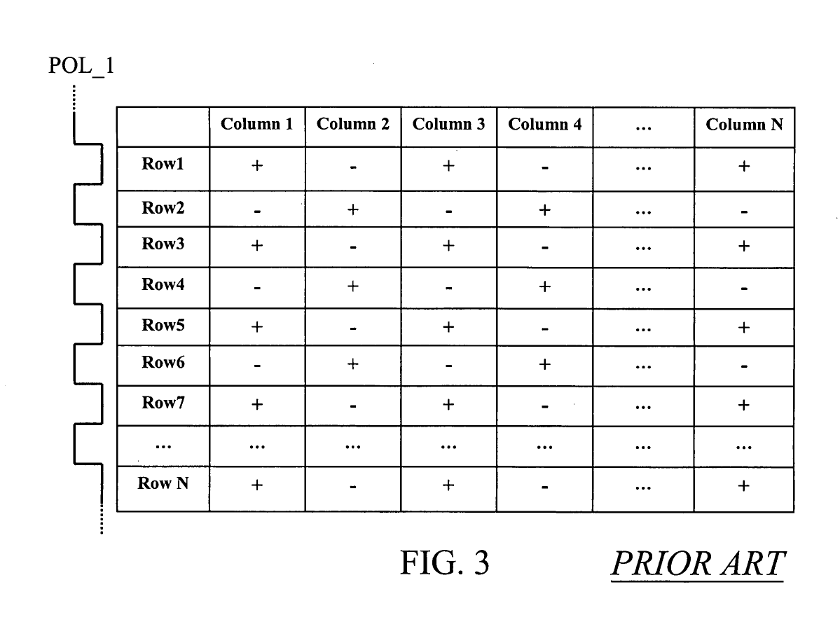

### DETAILED DESCRIPTION OF THE INVENTION

Preferred embodiments of the invention accompanied by drawings will be fully described. But it should be noted that people familiar with the skill can modify the invention described herein to obtain the same effect. Thus the description below is a general disclosure which does not mean limiting the invention.

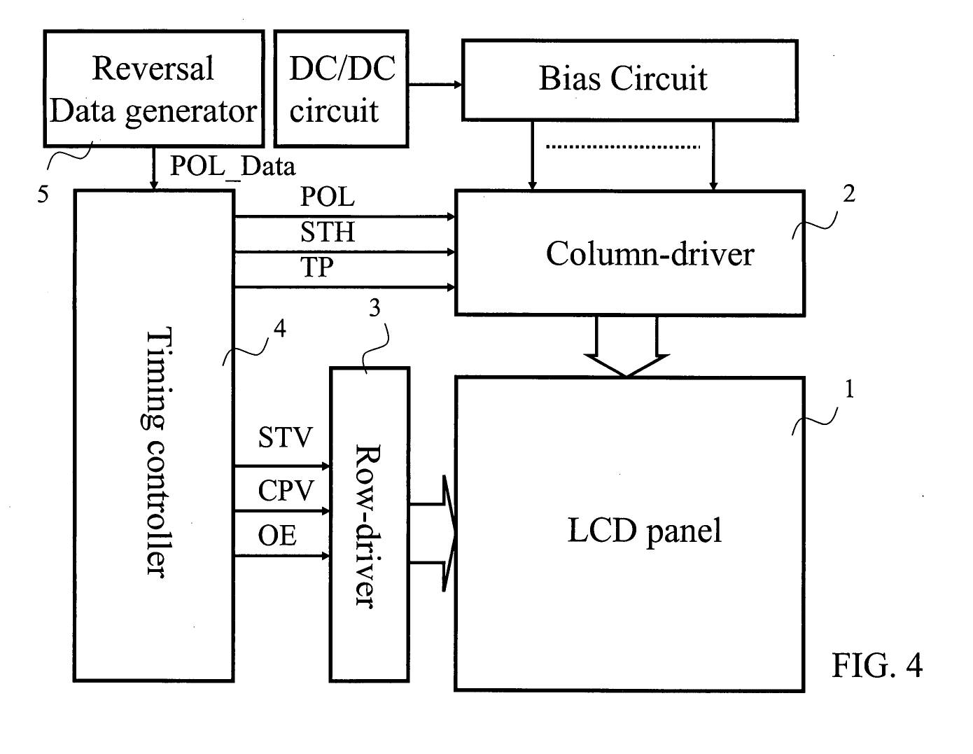

Referring to FIG. 4, a block diagram of the driver circuit of a TFT liquid crystal display module according to the invention is shown. The TFT liquid crystal display module comprises a LCD panel 1, a column-driver 2, a row-driver 3 and a timing controller 4, wherein the timing controller 4 provides a column start signal STH, a reversal signal POL, and a latch signal TP to the column-driver 2, and a row start signal STV, a row clock signal CPV, and an output enable signal OE to the row-driver 3.

In a preferred embodiment of the invention, the TFT liquid crystal display module includes a reversal data generator 5. The reversal data generator 5 outputs a reversal data signal POL_Data to the timing controller 4, which will output a non-periodic reversal signal to the column-driver 2 in reference to the reversal data signal POL_Data.

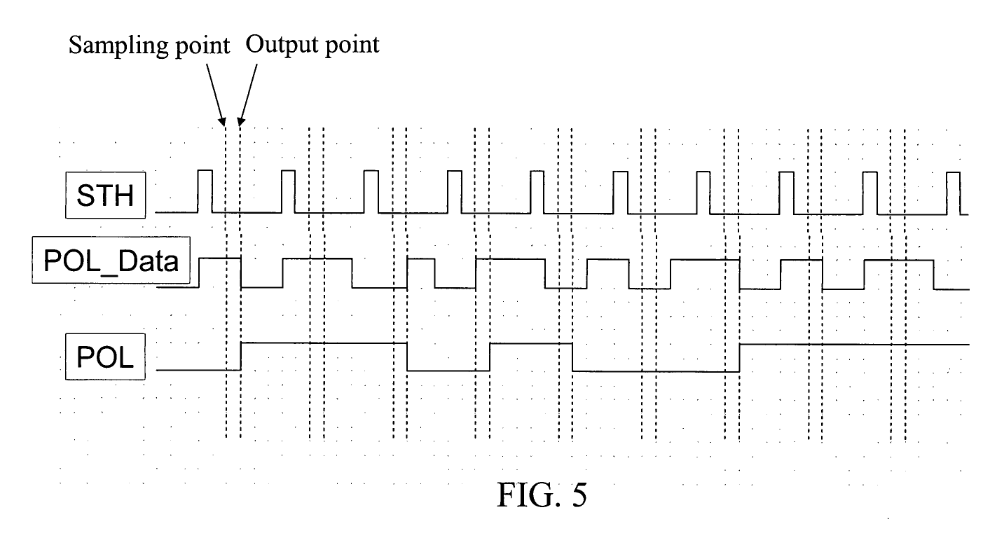

FIG. 5 is a timing diagram of the reversal signal POL corresponding to the column start signal STH according to the invention. According to the control signal specifications of a TFT LCD, the state change of the reversal signal POL is valid within a specific time range posterior to the column start signal STH. In a preferred embodiment of the invention, the state change of the reversal signal POL is at an output point posterior to the column start signal STH, while the timing of the output point conforms to the specifications of the TFT LCD control signal so that the state change of the non-periodic reversal signal POL is valid reversal. In light that the sampling timing of the column start signal is earlier than that of the output point, the timing controller 4 would sample the reversal data signal POL_Data to determine the state change potential of the reversal signal POL. In the sampling timing, when the reversal data signal POL_Data is L, the state change potential of the reversal signal POL is L. Conversely, when the reversal data signal POL_Data is H, the state change potential of the reversal signal POL is H.

In addition, the generation of the reversal data signal POL_Data is independent of the system clock of the timing controller 4, or the reversal data signal POL_Data itself is a randomly generated non-periodic signal.

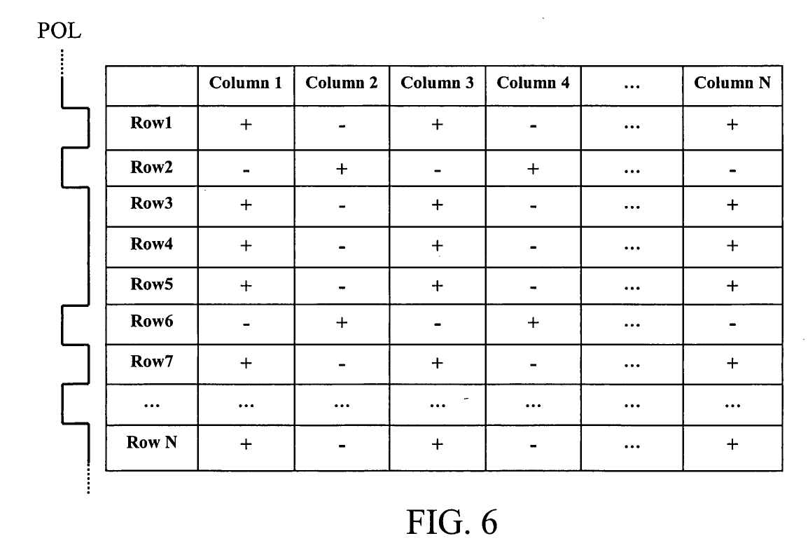

FIG. 6 is a diagram of the non-periodic reversal signal POL corresponding to the column image reversal according to the invention. The non-periodic reversal signal POL of the invention will decide the reversal state of respective pixel on the first column of the LCD panel 1, while the reversal state of each pixel on each row of the LCD panel 1 is dependent on the reversal state of its first pixel (i.e. the pixels on the first column).

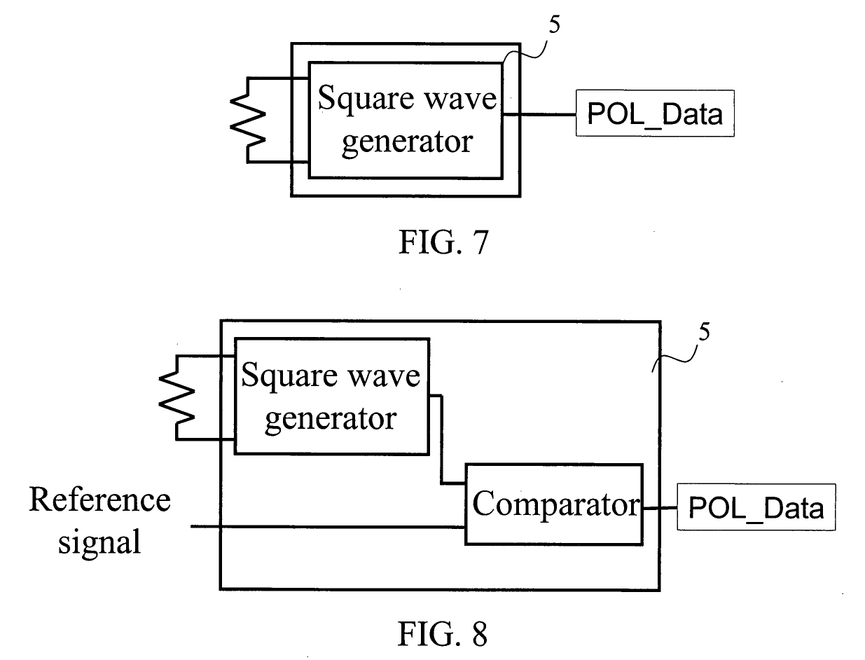

In a preferred embodiment of the invention, the reversal data generator 5 of the invention is independent of the timing of the timing controller 4 in the generation of the reversal data signal POL_Data. The reversal data generator 5 can be a square wave generator as shown in FIG. 7, and the frequency of the square wave generator is independent of the system clock of the timing controller 4 whose parameters may be determined by external components, such as resistors or capacitors, of the integrated circuit, so that the reversal data signal POL_Data output by the integrated circuit may be optimized by an external component. In light that the timings of reversal data signal POL_Data and timing controller 4 are independent of each other and freely corresponding to each other, so that the sampling of the reversal data signal POL_Data by the timing controller 4 caused by the random drift of these two timings will decide a non-periodic reversal signal POL.

In another embodiment of the invention, the reversal data generator 5 outputs a non-periodic reversal data signal POL_Data and comprises a square wave generator and a comparator as shown in FIG. 8. In addition, the frequency of the square wave generator is independent of the system clock of the timing controller 4 whose parameters may be determined by external components, such as resistors or capacitors, of the integrated circuit,. The comparator compares the output of the square wave generator with the reference signal input to the reversal data generator 5 to output a non-periodic reversal data signal POL_Data, while such reference signal may come from the column start signal or latch signal of the timing controller 4.

Embodiments of the present invention have been disclosed. All modifications and alterations without departing from the spirits of the invention and appended claims shall remain within the protected scope and claims of the invention.

What is claimed is:

1. A liquid crystal display module, comprising:
a timing controller to provide a plurality of signals to the column-driver and row-driver of the liquid crystal display panel; and
a reversal data generator to output a reversal data signal to said timing controller;
wherein said timing controller refers to said reversal data signal to output a reversal signal to said column-driver and said reversal signal is a non-periodic signal.

2. The liquid crystal display module according to claim 1, wherein said reversal data generator is a square wave generator.

3. The liquid crystal display module according to claim 1, wherein said reversal data generator refers to a reference signal to generate said reversal data signal.

4. The liquid crystal display module according to claim 3, wherein said reference signal is the column start signal output by said timing controller.

5. The liquid crystal display module according to claim 3, wherein said reference signal is the latch signal output by said timing controller.

6. The liquid crystal display module according to claim 1, wherein said reversal data generator is independent of said timing controller for generating said reversal data signal.

7. The liquid crystal display module according to claim 1, wherein said reversal data generator is independent of the timing of said timing controller for generating said reversal data signal.

8. The liquid crystal display module according to claim 1, wherein said reversal data signal is a non-periodic signal.

9. A liquid crystal display module, comprising:
a timing controller to provide a plurality of signals to the driver of the liquid crystal display panel; and
a reversal data generator to output a reversal data signal to the timing controller;
wherein the timing controller samples the reversal data signal based on a column start signal to output a reversal signal to said driver, and said reversal signal is a non-periodic signal.

10. The liquid crystal display module according to claim 9, wherein said reversal data signal is a non-periodic signal.

11. The liquid crystal display module according to claim 9, wherein said reversal data generator is a square wave generator.

12. The liquid crystal display module according to claim 9, wherein said reversal data generator refers to a reference signal to generate said reversal data signal.

13. The liquid crystal display module according to claim 12, wherein said reference signal is the column start signal output by said timing controller.

14. The liquid crystal display module according to claim 12, wherein said reference signal is the latch signal output by said timing controller.

15. The liquid crystal display module according to claim 9, wherein said reversal data generator is independent of the timing of said timing controller for generating said reversal data signal.

16. The liquid crystal display module according to claim 9, wherein said driver is a column-driver.

17. A reversal signal control method implemented in a liquid crystal display module, comprising the steps of:
providing a reversal data signal to a timing controller; and
said timing controller sampling said reversal data signal to output a non-periodic reversal signal to the driver of said liquid crystal display module.

18. The reversal signal control method according to claim 17, comprising the step of randomly producing said reversal data signal to make said reversal data signal a non-periodic signal.

19. The reversal signal control method according to claim 17, comprising the step of generating said reversal data signal independent of the timing of said timing controller.

20. The reversal signal control method according to 17, comprising the step of determining the state change of said non-cyclic reversal signal within a specific time range posterior to a column start signal.
